(19) United States
(12) Patent Application Publication
(10) Pub. No.: US 2008/0087674 A1
(43) Pub. Date: Apr. 17, 2008

(54) DOUBLE WALLED BEVERAGE CONTAINER

(76) Inventor: Erik Overgaard, Oslo (NO)

Correspondence Address: SHERR & NOURSE, PLLC, 620 HERNDON PARKWAY, SUITE 200, HERNDON, VA, 20170, US

(21) Appl. No.: 11/688,098

(22) Filed: Mar. 19, 2007

Related U.S. Application Data
(60) Provisional application No. 60/829,263, filed on Oct. 12, 2006.

(51) Int. Cl. A47J 41/00

(52) U.S. Cl. 220/592.16

(57) ABSTRACT

A container (e.g. a bottle) with an inner wall and an outer wall. Phase change material is maintained between the inner wall and the outer wall. Phase change material may serve as a temperature regulating mechanism. The temperature regulating mechanism may maintain a liquid (e.g. Vodka) stored in the bottle at a substantially consistent temperature (e.g. approximately 10 degrees Celsius) for a reasonable period of time when charged.

Priority is claimed to U.S. Provisional Patent Application No. 60/829,263 (filed in the U.S. Patent and Trademark Office on Oct. 12, 2006), which is herein incorporated by reference in entirety.

### BACKGROUND

Beverages are an-important part of the lives of all humans. Since the beginning of the human race, humans have been consuming beverages (e.g. water, juices, and alcohol) for sustenance and enjoyment. Over time, beverages have been crafted and developed tailored to the tastes and nutritional requirements of a given society. Along with the development of beverages, consumption habits and preferences have been cultivated specific to different beverages. For example, the alcoholic beverage Vodka was developed in Northern and Eastern Europe over more than a thousand years. Many varieties of Vodka are consumed at a relatively cold temperature and in a straight fashion, just like for example Cognacs. In fact, many high quality Vodkas must be consumed at and around the temperature range of 10-13 degrees Celsius in order for the consumer to enjoy the full taste of the spirit and aroma. It can be difficult in a social setting (e.g. a drinking establishment such as a bar) to maintain Vodka (and other beverages) at its ideal serving temperature for a reasonable amount of time. For example, if a group of patrons at a bar purchase a bottle of Vodka to be enjoyed straight over a couple of hours at their table, it may be difficult for the patrons to enjoy the fill taste of the Vodka due to their inability to maintain the Vodka in the bottle at the critical temperature range of 10-13 degrees Celsius.

### SUMMARY

Embodiments relate to an apparatus comprising a container (e.g. a bottle) with an inner wall and an outer wall with phase change material between the inner wall and the outer wall. In embodiments, phase change material can maintain liquid (e.g. Vodka) in the container (inside the inner wall) at a predetermined temperature (e.g. for Vodka, approximately 10-13 degrees Celsius). For example, if a group of patrons at a bar purchased a bottle of Vodka with a phase change material between an inner wall and an outer wall, they would be able to enjoy the full taste of the spirit and aroma over a couple of hours, since the Vodka could be maintained within an ideal serving temperature range of approximately 10-13 degrees Celsius for a prolonged period of drinking pleasure.

### DRAWINGS

FIG. 1 illustrates an example cross-sectional view of a bottle with phase change material between an outer wall and an inner wall.

FIG. 2 illustrates an example outside view of a bottle with phase change material between a outer wall and an inner wall, with the phase change material in a liquid substantially transparent state, indicating that the liquid (e.g. Vodka) inside the bottle (contained inside the inner wall) is not at an ideal serving temperature.

FIG. 3 illustrates an example outside view of a bottle with phase change material between a outer wall and an inner wall, with the phase change material in a solid non-transparent state, indicating that the liquid (e.g. Vodka) inside the bottle (contained inside the inner wall) is at an ideal serving temperature.

### DESCRIPTION

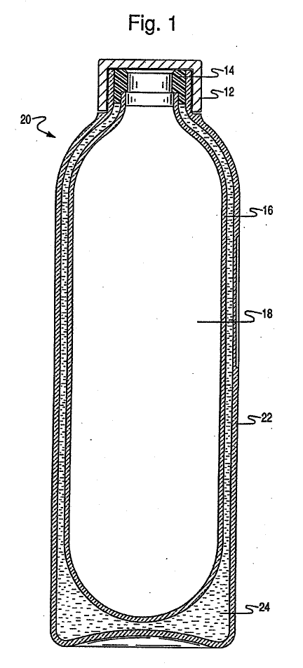

FIG. 1 illustrates an example cross-sectional view of container 20 (e.g. a bottle) having outer wall 22 and inner wall 16, in accordance with embodiments. In embodiment, phase change material 24 is contained between outer wall 22 and inner wall 16. Phase change material may serve as a temperature regulating mechanism for liquid 18 (e.g. Vodka) stored in container 20. In embodiments, phase change material 24 may maintain liquid 18 (e.g. Vodka) inside the container 20 at a predetermined temperature (e.g. below room temperature), which may be tailored to be the ideal serving temper. Liquid 18 inside container 20 may be spirits (e.g. Vodka, Gin, or other spirits), wine, beer, non-alcoholic beverage, and/or non-beverage liquids.

In embodiments, container 20 may be a bottle with a cap 12. The space between outer wall 22 and inner wall 16 may form a sealed chamber that contains phase change material 24, in accordance with embodiments. In embodiments, seal 14 near an opening of container 20 may seal the sealed chamber so that phase change material is permanently maintained in the sealed chamber. In embodiments, the sealed chamber may be formed along at least a portion of the sides of container 20 and/or the bottom of container 20. In FIGS. 1-3, container 20 is a bottle with a single sealed chamber that is formed along the sides and bottom of the container and sealed with seal 14 near the opening of container 20, in accordance with embodiments.

One of ordinary skill in the art would appreciate that other configurations of the sealed chamber can be appreciated. For example, there could be multiple sealed chambers, in accordance with embodiments. The sealed chamber could only be on a portion of the sides of a container, in accordance with embodiments. The sealed chamber could be only on the sides of a container, in accordance with embodiments. The sealed chamber could be on any portion of the sides and/or bottom and/or top of a container, in accordance with embodiments.

In embodiments, inner wall 16 may include material that is a good thermal conductor. In embodiments, inner wall 16 may contain glass or aluminum which are a good thermal conductors. In order to maintain liquid 18 at an ideal serving temperature, a good thermal conductor may be chosen to maximize thermal coupling between liquid 18 and phase change material 24, in accordance with embodiments. In embodiments, inner wall 16 is substantially transparent, so that liquid 18 inside container 20 can be seen from the outside when phase change material 24 is in a substantially transparent liquid state.

In embodiments, outer wall 22 may include a material that is a good thermal insulator. In embodiments, outer wall 22 may contain plastic which is a good thermal insulator. In order to maintain liquid 18 at an ideal serving temperature for the maximum amount of time, outer wall 22 being a good thermal insulator may prevent thermal coupling of phase change material 24 with the outside environment to maintain thermal energy inside container 20. In embodiments, outer wall 22 may be substantially transparent, so that the liquid 18 inside container 20 can be seen when phase change material 24 is in a substantially transparent liquid state.

Phase change material (e.g. phase change material 24) is a class of materials that use phase changes (e.g. melting or freezing) to absorb or release relatively large amounts of latent heat at relatively constant temperatures. Phase change material is disclosed in U.S. Pat. No. 6,574,971 to Suppes, which is hereby incorporated by reference in its entirety. Phase change materials allow for a micro encapsulation and a customized melt/freeze point. When the temperature becomes warmer than the freezing point, phase change materials liquefy and absorb and store heat. Conversely, when the temperature drops, the material will solidify and give off heat, warming the material coated or impregnated with phase change material.

Phase change materials are used for a wide range of applications in the industry, and are far superior to and comparable with ordinary ice or freeze gel for many applications. For example, the U.S. army uses a cold vest filled with a phase change material to keep soldiers cool in hot conditions; the material interacts with body heath. Phase change material may be used as an insulator for Pizza delivery packaging to keep the pizza hot during transport. It may be used in air conditioning devices to accumulate cold in order to save electricity consumption.

In embodiments, phase change material maintains alcohol (e.g. vodka) in a bottle between about at approximately 10° C. In embodiments, a liquid can be maintained at a prescribed temperature that is specifically tailored for the ideal temperature of the liquid. Phase change material used may be non-toxic and may be made out of food grade materials such as soy. Phase change material may be used for temperature moderation of vodka, and may be formulated to interact with the aroma flavor's ideal serving temperature at approximately 10° C. In embodiments, phase change material is tailored to have a melting and freezing point of approximately 10° C. In other words, at approximately 10° C. or below, the phase change material will be frozen and temperatures above approximately 10° C. the phase change material will be a liquid. When the phase change material is a solid and starts to melt to become a liquid, it may absorb large amounts of heat from its surroundings and thereby keep it cooler. Conversely when phase change material starts to go from a solid state to a liquid state it will release large amounts of heat and therefore aids in alcohol from getting too cold too quickly. It is the actual process of melting and freezing of phase change material that assists in temperature moderation.

In embodiments, phase change material 24 may maintain liquid 18 (e.g. Vodka) inside inner wall 16 of container 20 (e.g. a bottle) at a predetermined temperature (e.g. approximately 10° C. if the liquid is vodka). Phase change material 24 may interact with and absorb the temperature from liquid 18 through a physical reaction associated with phase change material 18. For example, when container 20 containing phase change material 24 is chilled at temperatures below the freezing point of the phase change material (e.g. 10° C. for a vodka container), phase change material will solidify. When container 20 is taken out of the chilled environment, phase change material 24 may absorb extra heat from its surroundings. The heat is absorbed and stored in the phase change material and not in the liquid. This may assist in keeping liquid chilled at a prescribed temperature (e.g. an ideal serving temperature of approximately 10° C. for Vodka).

In embodiments, phase change material 24 may act as a temperature control device for temperature maintenance and moderation of liquid 18 (e.g. Vodka or other beverage) inside container 20. For example, in the case of Vodka, phase change material 24 may keep and maintain Vodka for a prolonged period of time (e.g. 1.5-2 hours) at an ideal serving temperature at which the unique aroma comes in full blossom. Phase change material 24 may also keep liquid 18 inside container 20 from cooling down too fast. For example, low quality Vodkas sometimes mask their aroma and/or quality by over-cooling the Vodka. In the case of higher quality Vodkas, too cold a serving temperature may be undesirable as it would numb several of the aroma extracts and prevent the optimal taste experience of the formulation.

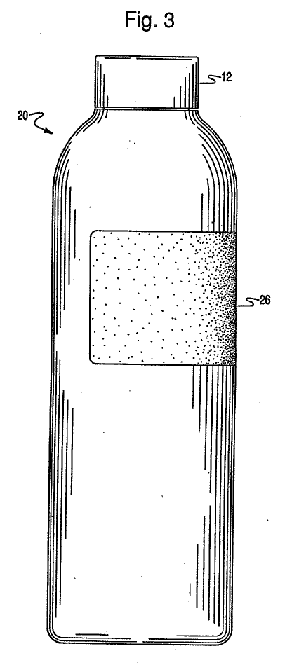

In embodiments, the appearance of phase change material 24 may indicate if the temperature of liquid 18 (e.g. Vodka) is at an predetermined set temperature (e.g. the ideal serving temperature of approximately 10° C. for Vodka). In embodiments, the appearance of phase change material 24 may be discriminated by the level of transparency and/or the color of phase change material 24. The level of transparency and/or color of the phase change material 24 may be a result of phase change material 24 transitioning from a liquid state to a solid state. For example, when liquid 18 in container 20 is maintained at a predetermine temperature (e.g. approximately 10° C. for Vodka), phase change material 24 is in a solid state (as shown in example FIG. 3). Likewise, phase change material 24 may change color when it transitions from a liquid state to a solid state, indicating that liquid 18 (e.g. Vodka) is at a predetermined temperature. The predetermined temperature is reflected in the chemistry of the phase change material, which may be tailored for a specific application (e.g. Vodka consumption at approximately 10° C.) of liquid 18.

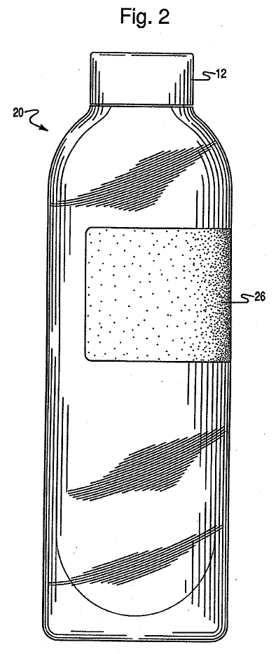

FIG. 2 illustrates container 20 when phase change material 24 is in a liquid substantially transparent state, in accordance with embodiments. When phase change material 24 is in a liquid substantially transparent state, it may be an indication to a consumer that liquid 18 is not at a predetermined ideal serving temperature (e.g. above 10 degree Celsius for Vodka). If inner wall 16 and outer wall 22 are substantially transparent, container 20 may appear transparent when phase change material 24 is in a liquid state, in accordance with embodiments.

FIG. 3 illustrates container 20 when phase change material 24 is in a solid non-transparent state, in accordance with embodiments. When phase change material 24 is in a solid non-transparent state, it may be an indication to a consumer that liquid 18 is at the predetermined ideal serving temperature (e.g. approximately 10 degrees Celsius for Vodka). If inner wall 16 and outer wall 22 are substantially transparent, container 20 may appear non-transparent or solid when phase change material 24 is in a solid state, in accordance with embodiments The foregoing embodiments (e.g. a container with phase change material between an inner wall and an outer wall) and advantages are merely examples and are not to be construed as limiting the appended claims. The above teachings can be applied to other apparatuses and methods, as would be appreciated by one of ordinary skill in the art. Many alternatives, modifications, and variations will be apparent to those skilled in the art.

What is claimed is:

1. An apparatus comprising a container, wherein the container comprises:
an outer wall;
an inner wall; and
phase change material between the outer wall and the inner wall.

2. The apparatus of claim 1, wherein the container is a bottle.

3. The apparatus of claim 1, wherein the container is configured to store liquid inside the inner wall.

4. The apparatus of claim 3, wherein the phase change material is configured to maintain the liquid at a predetermined temperature.

5. The apparatus of claim 4, wherein the predetermined temperature is below room temperature.

6. The apparatus of claim 5, wherein the liquid is vodka and the predetermined temperature is 10 degree Celsius.

7. The apparatus of claim 4, wherein the appearance of the phase change material indicates if the temperature of the liquid is at approximately the predetermined temperature.

8. The apparatus of claim 7, wherein:
the liquid is at approximately the predetermined temperature if the phase change material is in a solid non-transparent state; and
the liquid is above the predetermined temperature if the phase change material is in a liquid substantially transparent state.

9. The apparatus of claim 4, wherein the melting point of the phase change material is at approximately the predetermined temperature.

10. The apparatus of claim 3, wherein the liquid is alcoholic beverage.

11. The apparatus of claim 10, wherein the alcoholic beverage is a spirit.

12. The apparatus of claim of claim 11, wherein the spirit is vodka.

13. The apparatus of claim 3, wherein the liquid is non-alcoholic beverage.

14. The apparatus of claim 1, wherein the space between the outer wall and the inner wall forms at least one sealed chamber, wherein the phase change material is contained inside said at least one sealed chamber.

15. The apparatus of claim 14, wherein said at least one sealed chamber is formed along the sides of the container.

16. The apparatus of claim 14, wherein said at least one sealed chamber is formed on the bottom of the container.

17. The apparatus of claim 14, wherein said at least one sealed chamber is formed along the sides of the container and on the bottom of the container.

18. The apparatus of claim 14, wherein the container comprises:
an opening; and
a seal near the opening that seals said at least one sealed chamber.

19. The apparatus of claim 1, wherein the inner wall comprises a material that is a good thermal conductor.

20. The apparatus of claim 19, wherein the good thermal conductor is glass.

21. The apparatus of claim 1, wherein the outer wall comprises a material that is a good thermal insulator.

22. The apparatus of claim 21, wherein the good thermal insulator is plastic.

23. The apparatus of claim 1, wherein the container comprises a rubber label.
